(19) United States
(12) Patent Application Publication
(10) Pub. No.: US 2020/0102453 A1
(43) Pub. Date: Apr. 2, 2020

(54) CONDUCTIVE THERMOPLASTIC POLYCARBONATE/ACRYLONITRILE BUTADIENE STYRENE (PC/ABS) POLYMER WITH NANOMATERIALS AND ARTICLES AND METHODS THEREOF

(71) Applicant: Lockheed Martin Corporation, Bethesda, MD (US)

(72) Inventors: James A. Waicukauski, Bel Air, MD (US); Venugopala Rao Basava, Perry Hall, MD (US); Joseph Herbert Mills, Kingsville, MD (US); Rikard K. Haraldsson, Elkton, MD (US); James Alan Gubisch, Baltimore, MD (US)

(73) Assignee: Lockheed Martin Corporation, Bethesda, MD (US)

(21) Appl. No.: 16/150,021

(22) Filed: Oct. 2, 2018

(51) Int. Cl. C08L 55/02; C08K 3/04; C08L 33/08; C08L 33/10; C08L 69/00; B29C 64/118; B29B 9/02; B29B 9/16; B29B 7/58

(52) U.S. Cl. CPC C08L 55/02; C08K 3/041; C08L 33/08; C08L 33/10; B82Y 30/00; B29C 64/118; B29B 9/02; B29B 9/16; B29B 7/588; C08L 69/00

(57) ABSTRACT

An electrically conductive thermoplastic composition comprised of at least one thermoplastic polycarbonate/acrylonitrile-butadiene-styrene (PC/ABS) polymer, at least one electrically conductive material containing carbon nanostructures or nanomaterials, and optionally at least one ethylene/alkyl-(meth)acrylate copolymer. The conductive thermoplastic composition can be injection molded and/or printable using additive manufacturing techniques.

The present disclosure relates to a conductive thermoplastic composition, particularly a conductive thermoplastic composition comprised of at least a thermoplastic polycarbonate/acrylonitrile-butadiene-styrene (PC/ABS) polymer and nanomaterials.

### SUMMARY

According to one or more embodiments of the disclosed subject matter, a composition comprising an electrically conductive polymer composite is described or provided. The composite can comprise: at least one thermoplastic material comprising thermoplastic polycarbonate/acrylonitrile-butadiene-styrene polymer; at least one electrically conductive material comprising carbon nanostructures; and at least one ethylene/alkyl-(meth)acrylate copolymer.

One or more embodiments of the disclosed subject matter can also involve a method of preparing a composition comprising an electrically conductive polymer composite. The composition can comprise at least one thermoplastic material comprising thermoplastic polycarbonate/acrylonitrile-butadiene-styrene polymer, at least one electrically conductive material comprising carbon nanostructures, and at least one ethylene/alkyl-(meth)acrylate copolymer. The method can comprise: (a) combining particulate thermoplastic material comprising thermoplastic polyurethane, the electrically conductive material comprising carbon nanostructures and the ethylene/alkyl-(meth)acrylate copolymer in a liquid dispersing medium to form at least one mixture; (b) subjecting the mixture to sufficient agitation under high shear to provide a substantially uniform dispersion; and (c) substantially removing the liquid dispersing medium from the dispersion of the subjecting (b) to form the composite, where the particulate thermoplastic material, the carbon nanostructures and the ethylene/alkyl-(meth)acrylate copolymer are distributed substantially uniformly in the composite.

Additionally, one or more embodiments of the disclosed subject matter can pertain to a method of forming a three-dimensional article of manufacture from an electrically conductive polymer composite. The composite can comprise: at least one thermoplastic material comprising thermoplastic polycarbonate/acrylonitrile-butadiene-styrene polymer, at least one electrically conductive material comprising carbon nanostructures, and at least one ethylene/alkyl-(meth)acrylate copolymer. The method can comprise: providing the electrically conductive polymer composite; and forming the three-dimensional article of manufacture out of the provided electrically conductive polymer composite.

The preceding summary is to provide an understanding of some aspects of the disclosure. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The accompanying drawings, which are incorporated in and constitute a part of the specification, are illustrative of one or more embodiments of the disclosed subject matter, and, together with the description, explain various embodiments of the disclosed subject matter. Further, the accompanying drawings have not necessarily been drawn to scale, and any values or dimensions in the accompanying drawings are for illustration purposes only and may or may not represent actual or preferred values or dimensions. Where applicable, some or all select features may not be illustrated to assist in the description and understanding of underlying features.

FIG. 1 is a flow chart of a method according to one or more embodiments of the disclosed subject matter.

FIG. 2 is a graph demonstrating the EMI shielding effectiveness of a composition according to Example 1 for 3D printing and injection molding.

FIG. 3 shows an article of manufacture in the form of a mobile device case made using a composition according to one or more embodiments of the disclosed subject matter.

FIG. 4 shows an article of manufacture in the form of an EMI shielding enclosure made using a composition according to one or more embodiments of the disclosed subject matter.

FIG. 5 shows an article of manufacture in the form of a nozzle made using a composition according to one or more embodiments of the disclosed subject matter.

FIG. 6 shows an article of manufacture in the form of a panel or tile made using a composition according to one or more embodiments of the disclosed subject matter.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more” or “at least one.” The phrases “at least one,” “one or more,” “or,” and “and/or” are open-ended expressions that can be both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” can mean A alone, B alone, C alone, A and B together, A and C together, B and C together, or A, B and C together. It is also to be noted that the terms “comprising,” “including,” and “having” can be used interchangeably and are inclusive and, therefore, specify the presence of stated items, but do not preclude the presence of other items.

All disclosures of ranges include the endpoints of the ranges and are disclosures of all values and further divided ranges within the entire range. Also, all values and subranges within a numerical limit or range are specifically included as if explicitly written out. Further, all references, patents, applications, tests, standards, documents, publications, brochures, texts, articles, etc. mentioned herein are incorporated herein by reference in their entirety.

As noted above, embodiments of the present disclosure involve a conductive thermoplastic composition, particularly a conductive thermoplastic composition comprised of at least one thermoplastic material comprising thermoplastic polycarbonate/acrylonitrile-butadiene-styrene polymer and at least one electrically conductive material comprising nanostructures (e.g., carbon nanostructures). The conductive thermoplastic composition can also be comprised of at least one ethylene/alkyl-(meth)acrylate copolymer.

According to one or more embodiments of the disclosed subject matter, the particulate thermoplastic material, the electrically conductive material (including the nanostructures) and/or the ethylene/alkyl-(meth)acrylate copolymer can be distributed substantially uniformly in the composite. For example, in at least one embodiment, the at least one electrically conductive material can be distributed substantially uniformly in the composite to form an electrically conductive network. Further, the nanostructures can be nanotubes, such as carbon nanotubes. And in one or more embodiments, the at least one ethylene/alkyl-(meth)acrylate copolymer can be ethylene methyl acrylate copolymer, as a non-limiting example.

According to one or more embodiments, the conductive thermoplastic composition can be injection moldable and/or additive manufactured, for instance, via fused filament fabrication (FFF) additive manufacturing, and can exhibit certain desirable mechanical properties and certain desirable electrical properties. Non-limiting examples of such mechanical properties include one or more of suitable strength/modulus, relatively low weight, and improved dimensional stability. Non-limiting examples of such electrical properties include suitable electrostatic discharge (ESD) accommodation, suitable electromagnetic interference (EMI) shielding, and suitable radio frequency interference (RFI) accommodation.

There are two basic types of plastic: thermosetting, which cannot be resoftened after being subjected to heat and pressure; and thermoplastic, which can be repeatedly softened and remolded by heat and pressure. When heat and pressure are applied to a thermoplastic binder, the chainlike polymers slide past each other, giving the material plasticity. However, when heat and pressure are initially applied to a thermosetting binder, the molecular chains become crosslinked, thus preventing any slippage if heat and pressure are reapplied.

Additive manufacturing, which may be referred to as three-dimensional (3D) printing, may create physical articles (e.g., objects, device, component, structures, or parts) based upon a computer-controlled program which instructs a 3D printer how to deposit successive layers of extruded material which may then fuse together to form the printed article. Fused deposition modeling (FDM), which may be referred to as fused filament fabrication (FFF), is one such additive manufacturing process. Other 3D printing techniques may include selective laser sintering (SLS) techniques and inkjet printing techniques. When using an electrically conductive thermoplastic composite in the form of a filament pellet or powder, such 3D printing techniques may form or create printable electronics, such as circuitry and power sources which may then be incorporated directly into functional printed articles. Embodiments of the disclosed subject matter are not limited to the additive manufacturing techniques mentioned above.

Plastic materials may be used as the filament material for 3D printing. For example, acrylonitrile butadiene styrene (ABS) and polylactic acid (PLA) can be used for an FDM-type printer. However, such plastic materials, used alone, may have unsuitable strength, durability, and/or conductivity characteristics. More specifically, ABS, alone, can have some acceptable mechanical properties, but can suffer from relatively large volumetric shrinkage and the generation of unpleasant odors. PLA, on the other hand, alone, can have less volumetric shrinkage, which can allow printing without a heated build envelope. However, PLA may still suffer from a number of drawbacks, including unsuitable impact strength and a relatively low softening temperature, which may lead to difficulties with extrusion and printing quality.

In order to enable the successful three-dimensional (3D) printing of thermoplastic composites, in particular electrically conductive thermoplastic composites, not only does melt rheology need to be taken into account, but also certain mechanical properties of the materials present in these composites in their solid state. In other words, a complex combination of the materials in such composites delivering a suitable combination of mechanical properties in the solid state as well as suitable melt viscoelastic properties may be required to enable successful three-dimensional (3D) printing of such composites. In addition, in carrying out injection molding, fused filament fabrication (FFF) techniques, and selective laser sintering (SLS) fabrication techniques with such composites, the viscoelastic behavior of the material present in such composites when in a molten state may also play a role in successfully carrying out such techniques.

According to embodiments of the disclosed subject matter, an electrically conductive material can be incorporated into such composites. As a non-limiting example, one electrically conductive material which may be incorporated is carbon nanostructures (CNS). Generally, CNS may exist as discontinuous, highly graphitic materials, may also be highly compatible with certain polymer processing techniques, and thus may be dispersed in isotropic or anisotropic mode. CNS may exhibit suitable mechanical properties, may have relatively high electrical and thermal conductivities, and may be compatible with a wide range of materials. Carbon nanofiber surfaces may also be functionalized to improve their compatibility with the polymer matrix present in the composite, or to render such carbon nanofibers more useful for specific applications. When incorporated into thermoplastic polymer-containing composites according to one or more embodiments of the disclosed subject matter, these carbon nanofibers (along with any other electrically conductive components such as graphene nanoplatelets and/or conductive metal nanoparticulates) may increase tensile strength, compression strength, Young's modulus, interlaminar shear strength, and fracture toughness, as well as vibration damping of the polymer-containing composite.

Thermoplastic Polycarbonate/Acrylonitrile-Butadiene-Styrene (PC/ABS)

The thermoplastic PC/ABS polymers according to one or more embodiments of the disclosed subject matter can be comprised of from about 50 to about 90 wt % of a polycarbonate resin and from about 10 to about 50 wt % of an acrylonitrile-butadiene-styrene (ABS) copolymer, preferably from about 60 to 80 wt % of a polycarbonate resin and from about 20 to 40 wt % of ABS copolymer, and more preferably about 65 to 75 wt % of a polycarbonate resin and from about 25 to 35 wt % of ABS copolymer. Small amounts (e.g., up to about 10 wt %) of additional comonomer, such as methyl methacrylate, ethyl acrylate, alpha-methylstyrene, vinyltoluene, acrylonitrile, or the like, may be included in the manufacture of some ABS according to embodiments of the disclosed subject matter.

The thermoplastic PC/ABS polymers according to embodiments of the disclosed subject matter can have an average weight average molecular weight (Mw) ranging from 15,000 to 250,000 g/mol, preferably from 20,000 to 200,000 g/mol, and more preferably from 25,000 to 100,000 g/mol.

The polycarbonate (PC) resin according to embodiments of the disclosed subject matter may be selected from aromatic polycarbonates and/or aromatic polyester carbonates.

In at least one embodiment, the production of aromatic polycarbonates can take place by reacting diphenols with carbonic acid halides, preferably phosgene, and/or with aromatic dicarboxylic acid dihalides, preferably benzenedicarboxylic acid dihalides, by the interfacial polycondensation process, optionally using chain terminators (e.g., monophenols), and optionally using trifunctional or more than trifunctional branching agents (e.g., triphenols or tetraphenols). Production by a melt polymerization process is also possible by reacting diphenols with a carbonate, such as diphenyl carbonate.

Diphenols for the production of aromatic polycarbonates and/or aromatic polyester carbonates can be those of formula (I):

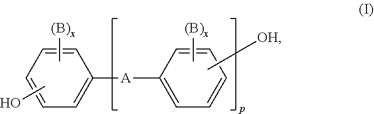

wherein A denotes a single bond, C₁ to C₅ alkylene, C₂ to C₅ alkylidene, C₅ to C₆cycloalkylidene, —O—, —SO—, —CO—, —S—, —SO₂—, C₆ to C₁₂ arylene, on to which other aromatic rings optionally containing hetero atoms can be condensed, or a residue of formula (II) or (III)

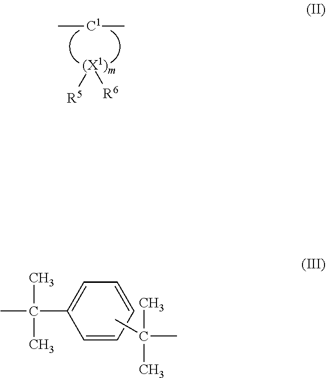

wherein

B denotes in each case C₁ to C₁₂ alkyl, preferably methyl, halogen, preferably chlorine and/or bromine,

x each independently of one another denotes 0, 1 or 2,

p denotes 1 or 0, and

R⁵ and R⁶ can be selected for each X¹ individually and denote, independently of one another, hydrogen or C1 to C6 alkyl, preferably hydrogen, methyl or ethyl,

X¹ denotes carbon, and

m denotes a whole number from 4 to 7, preferably 4 or 5, with the proviso that, on at least one X¹ atom, R⁵ and R⁶ are simultaneously alkyl.

Preferred diphenols include hydroquinone, resorcinol, dihydroxydiphenols, bis(hydroxyphenyl)-C1-C5-alkanes, bis(hydroxyphenyl)-C5-C6-cycloalkanes, bis(hydroxyphenyl)ethers, bis(hydroxy-phenyl) sulfoxides, bis(hydroxyphenyl) ketones, bis(hydroxyphenyl) sulfones and α,α-bis(hydroxy-phenyl) diisopropylbenzenes and the ring-brominated and/or ring-chlorinated derivatives thereof.

Particularly preferred diphenols are selected from 4,4′-dihydroxydiphenyl, bisphenol A, 2,4-bis(4-hydroxy-phenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone and the di- and tetrabrominated or chlorinated derivatives thereof, such as e.g. 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is particularly preferred.

The diphenols can be used individually or any mixtures thereof.

For the production of thermoplastic aromatic polycarbonates, suitable chain terminators are, for example, phenol, p-chlorophenol, p-tert-butylphenol or 2,4,6-tribromophenol, but also long-chain alkylphenols, such as 4-[2-(2,4,4-trimethylpentyl)]phenol, 4-(1,3-tetramethylbutyl)phenol according to DE-A 2 842 005 or monoalkylphenol or dialkylphenols with a total of 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The quantity of chain terminators to be used can be generally between 0.5 mole % and 10 mole %, based on the molar sum of the diphenols used in each case.

The thermoplastic polycarbonates can have an average weight average molecular weight (Mw) as measured by GPC (gel permeation chromatography with polycarbonate standard) ranging from 10,000 to 200,000 g/mol, preferably from 15,000 to 80,000 g/mol, and particularly preferably from 24,000 to 32,000 g/mol.

The thermoplastic, aromatic polycarbonates can be branched in a known manner, preferably by incorporating 0.05 to 2.0 mole %, based on the sum of diphenols used, of trifunctional or more than trifunctional compounds (e.g., compounds with three or more phenolic groups). Linear polycarbonates can also be used.

Both homopolycarbonates and copolycarbonates are suitable. In addition to bisphenol A homopolycarbonates, other preferred polycarbonates include the copolycarbonates of bisphenol A with up to 15 mole %, based on the molar sums of diphenols, of other diphenols mentioned as preferred or particularly preferred, in particular 2,2-bis(3,5-dibromo-4-hydroxyphenyl)propane.

Aromatic dicarboxylic acid dihalides for the production of aromatic polyester carbonates can be the diacid dichlorides of isophthalic acid, terephthalic acid, diphenyl ether-4,4′-dicarboxylic acid and naphthalene-2,6-dicarboxylic acid. Particularly preferred are mixtures of the diacid dichlorides of isophthalic acid and terephthalic acid in a ratio of between 1:20 and 20:1.

In the production of polyester carbonates, a carbonic acid halide, preferably phosgene, can be additionally used as a bifunctional acid derivative. As chain terminators for the production of the aromatic polyester carbonates, in addition to the already mentioned monophenols, their chlorocarbonic acid esters and the acid chlorides of aromatic monocarboxylic acids, which may optionally be substituted by C1 to C22 alkyl groups or by halogen atoms, as well as aliphatic C2 to C22 monocarboxylic acid chlorides, are also suitable. The quantity of chain terminators can be in each case 0.1 to 10 mole %, based in the case of phenolic chain terminators on moles of diphenol and in the case of monocarboxylic acid chloride chain terminators on moles of dicarboxylic acid dichloride.

In the production of aromatic polyester carbonates, it is additionally possible to use one or more aromatic hydroxycarboxylic acids. The aromatic polyester carbonates can be both linear and branched in a known manner (cf. DE-A 2 940 024 and DE-A 3 007 934), with linear polyester carbonates being preferred.

As branching agents it is possible to use, for example, trifunctional or polyfunctional carboxylic acid chlorides, such as trimesic acid trichloride, cyanuric acid trichloride, 3,3′-,4,4′-benzophenone-tetracarboxylic acid tetrachloride, 1,4,5,8-naphthalenetetracarboxylic acid tetrachloride or pyromellitic acid tetrachloride, in quantities of 0.01 to 1.0 mole % (based on dicarboxylic acid dichlorides used) or trifunctional or polyfunctional phenols, such as phloroglucinol, 4,6-dimethyl-2,4,6-tri(4-hydroxyphenyl) hept-2-ene, 4,6-dimethyl-2,4-6-tri(4-hydroxyphenyl)heptane, 1,3,5-tri-(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in quantities of 0.01 to 1.0 mole % based on diphenols used. Phenolic branching agents can be charged together with the diphenols; acid chloride branching agents can be introduced together with the acid dichlorides.

In the thermoplastic aromatic polyester carbonates, the proportion of carbonate structural units can vary. The proportion of carbonate groups can be up to 100 mole %, preferably up to 80 mole %, more preferably up to 50 mole %, based on the sum of ester groups and carbonate groups. Both the ester and the carbonate portion of the aromatic polyester carbonates can be present in the form of blocks or randomly distributed in the polycondensate.

The thermoplastic aromatic polycarbonates and polyester carbonates can be used individually or in any mixture.

In the case of thermoplastic PC/ABS powders, such powders can have an average particle diameter of from 1 to 250 preferably an average particle diameter of 50 to 200 μm, and especially preferably an average particle diameter of from 100 to 150 μm. The resulting thermoplastic PC/ABS can have a melting enthalpy (as measured by DSC) ranging from 5.5 J/g to 100 J/g, preferably from 10 J/g to 50 J/g, and especially preferably from 15 J/g to 45 J/g.

In the composition according to embodiments of the disclosed subject matter, an amount of the thermoplastic PC/ABS, based on the entire composition, can range from 50 to 98 wt %, preferably from 65 to 90 wt %, and especially preferably from 70 to 80 wt %.

Nanostructures

As noted above, nanostructures according to embodiments of the disclosed subject matter can be carbon nanostructures. For example, in one or more embodiments of the disclosed subject matter, the nanostructures can be carbon nanostructures in the form of cylindrical nanostructures having graphene layers arranged as stacked cones, cups, or plates. Carbon nanofibers with graphene layers wrapped and arranged as cylinders are commonly referred to as carbon nanotubes. Carbon nanofibers may be produced either in a vapor-grown form or by electro spinning. Vapor-grown carbon nanofibers may be in the form of a free-flowing powder (e.g., wherein 99% of the carbon mass is in a fibrous form) known as multi-walled carbon nanotubes (MWCN), preferably branched, or stacked up carbon nanotubes (SCCNT) where the graphene plane surface is canted from the fiber axis, thus exposing the plane edges present on the interior and exterior surfaces of the carbon nanotubes, and may be produced by the floating catalyst method in the vapor phase by decomposing carbon-containing gases, such as methane, ethane, acetylene, carbon monoxide, benzene, and coal gas, in presence of floating metal catalyst particles inside a high-temperature reactor. Ultrafine particles of the catalyst may be either carried by the floating gas into the reactor or produced directly in the reactor by decomposing of the catalyst precursor. One such catalyst is iron, which may be produced by the decomposition of ferrocene. However other metals alone or in combination may be utilized as well as catalysts.

Carbon nanofibers suitable for embodiments of the disclosed subject matter may have an average diameter in the range of from about 3 to about 50 nm, preferably of from about 5 to about 12 nm, depending upon the grade and may have lengths of, for example, in the range of from about 5 to about 200 microns, preferably of from about 25 to about 140 microns.

Carbon nanofibers may undergo post treatment after production, including removing impurities on their surface, such as tar and other aromatic hydrocarbons, by a process called pyrolytic stripping, that involves heating, for example, to about 1000° C. in a reducing atmosphere. Sometimes heating, for example, to 3000° C. may be used to impart higher tensile strength and tensile modulus by graphitizing the surface of the carbon fibers. However, the heat treatment which may achieve an improved combination of mechanical and electrical properties may be found at a temperature of, for example, about 1500° C. In embodiments of the composites, commercially available sources of suitable carbon nanofibers may be obtained, for example, from Applied Sciences Inc. as grade PR-24XT-LHT, PR-25XT-LHT as well as Aldrich product 719803, Grupo Antolin carbon nanofibers (GANF1 and GANF3).

In some embodiments, the carbon nanotube is selected from single-walled carbon nanotubes, multi-wall carbon nanotube, hydroxylated modified single arm carbon nanotube, carboxylated modified single arm carbon nanotube, amino modified single arm carbon nanotube, hydroxylated multi-arm carbon nanotube, carboxylated multi-arm carbon nanotube, amino modified multi-arm carbon nanotube, nitrogen-doped single-arm carbon nanotube, sulfur-doped single-arm carbon nanotube, boron doped single arm carbon nanotube, nitrogen-doped multi-arm carbon nanotube, and sulfur-doped arm carbon nanotube. The carbon nanotube may also be post-coated with polyethylene glycol (PEG). Therefore, the carbon nanotube can further improve the conductive plastic conductive capacity and stability.

In the composition, an amount of the carbon nanostructures, based on the entire composition, can range from 1 to 20 wt %, preferably from 2 to 15 wt %, especially preferably from 5 to 10 wt %.

Ethylene/Alkyl-(meth)acrylate Copolymer

Suitable alkyl groups in the alkyl-(meth)acrylate include alkyl groups having one to eight carbon atoms, for instance, with or without significant branching. The relative amount and choice of the alkyl group present in the alkyl (meth)acrylate ester comonomer can play a role in establishing to what degree the resulting ethylene copolymer may be considered a polar polymeric constituent in the thermoplastic composition. Desirably, the alkyl group in the alkyl-(meth)acrylate comonomer has from one to four carbon atoms, preferably from one to three carbon atoms, and particularly preferably from one to two carbon atoms. Preferably, the alkyl-(meth)acrylate comonomer is methyl acrylate.

The monomer other than methyl acrylate may be, for example, ethyl acrylate, ethyl methacrylate, propyl acrylate, propyl methacrylate, butyl acrylate, butyl methacrylate, 2-ethylhexyl acrylate, and 2-ethylhexyl methacrylate.

It is further contemplated that a mixture of two or more ethylene/alkyl (meth)acrylate copolymers may be used in the compositions in place of a single copolymer, provided that the average values of the comonomer content are within the ranges indicated above.

In the composition, an amount of the ethylene/alkyl (meth)acrylate copolymer, based on the entire composition, can range from 1 to 20 wt %, preferably from 2 to 15 wt %, especially preferably from 5 to 10 wt %.

The amount of the alkyl-(meth)acrylate commoner in the ethylene/alkyl-(meth)acrylate copolymer can be from 10 to 90 wt %, preferably 20 to 80 wt %, more preferably 25 to 70 wt %. The amount of the alkyl-(meth)acrylate commoner in the ethylene/alkyl-(meth)acrylate copolymer may also be from 40 to 60 wt %, or about 50 wt %, based on the copolymer.

The glass transition temperature of the ethylene/alkyl-(meth)acrylate copolymer can be from 40 to 90° C., preferably from 45 to 80° C., particularly preferably from 50 to 75° C.

The number average molecular weight (Mn) of the ethylene/alkyl-(meth)acrylate copolymer can be from 20,000 to 100,000, preferably from 30,000 to 90,000, particularly preferably from 40,000 to 80,000, and especially preferably from 50,000 to 70,000.

The mass average molecular weight (Mw) of the ethylene/alkyl-(meth)acrylate copolymer can be preferably from 30,000 to 200,000, preferably from 40,000 to 150,000, particularly preferably from 50,000 to 125,000, and especially preferably from 75,000 to 100,000.

The molecular weight distribution (Mw/Mn) of the ethylene/alkyl-(meth)acrylate copolymer can be from 1 to 4, preferably from 1.2 to 3, particularly preferably from 1.5 to 2.

The melt viscosity of the ethylene/alkyl-(meth)acrylate copolymer can be from 10 to 1,000 Pa·s, preferably from 50 to 500 Pa·s, particularly preferably from 100 to 300 Pa·s, at a kneading temperature of from 190 to 200° C.

The melting point of the ethylene/alkyl-(meth)acrylate copolymer can be from 80 to 150° C., preferably from 90 to 125° C., especially preferably from 100 to 115° C.

The density of the ethylene/alkyl-(meth)acrylate copolymer can be from 0.90 to 1.0 g/mL, preferably from 0.91 to 0.97 g/mL, especially preferably from 0.92 to 0.95 g/mL, or about 0.944 g/mL.

In at least one embodiment, the composition may optionally further comprise a low density polyethylene, which may advantageously increase the melt point temperature, tensile strength, and/or flex modulus of the thermoplastic composition. Thus, the composition may comprise about 1% to about 20% by weight of a low density polyethylene, preferably about 5 to 15% of the low density polyethylene, and particularly preferably about 10% by weight, based on the composition. The low density polyethylene preferably can have a density of about 0.910 to 0.935 g/cc.

A low density polyethylene produced via autoclave typically can have a branched structure, a melt index of about 4.5, a density of about 0.923 g/cc, and/or relatively low crystallinity. Alternatively, a linear low density polyethylene having a density similar to that of an autoclave-produced low density polyethylene (i.e., 0.95 to 0.930 g/cc) can be synthesized through a variety of other processes such as gas phase, solution, slurry, or tubular reactor in the presence or absence of a catalyst.

While low density polyethylene can have a high level of long-chain branching, linear low density polyethylene can have high levels of short-chain branching. As a result, autoclaved-produced low density polyethylene can contribute to flexible and soft end-products, whereas linear low density polyethylene displays can have better tear and impact film properties. Accordingly, it is contemplated that a low density polyethylene utilized in the composition can be a low density polyethylene or linear low density polyethylene, or a combination thereof, depending on the desired characteristics of the end-product.

In one or more embodiments, the composition may further comprise one or more plasticizer(s), nanoscopic particulate filler(s), and the thermal stabilizer(s). Additionally or alternatively, in one or more embodiments, the composition can consist essentially of at least one thermoplastic material comprising thermoplastic polycarbonate/acrylonitrile-butadiene-styrene polymer; at least one electrically conductive material comprising carbon nanostructures; and at least one ethylene/alkyl-(meth)acrylate copolymer. And in yet one or more other embodiments, the composition can consist of: at least one thermoplastic material comprising thermoplastic polycarbonate/acrylonitrile-butadiene-styrene polymer; at least one electrically conductive material comprising carbon nanostructures; and at least one ethylene/alkyl-(meth)acrylate copolymer.

Preferably, the composition comprises, consists essentially of, or consists of: 50 to 98 wt % of the at least one thermoplastic material comprising thermoplastic polycarbonate/acrylonitrile-butadiene-styrene polymer; 1 to 20 wt % of the at least one carbon nanotube; and 1 to 20 wt % of the ethylene methyl acrylate.

Particularly preferably, the composition comprises, consists essentially of, or consists of: 70 to 94 wt % of the at least one thermoplastic material comprising thermoplastic polycarbonate/acrylonitrile-butadiene-styrene polymer; 2 to 15 wt % of the at least one carbon nanotube; and 2 to 15 wt % of the ethylene methyl acrylate.

Especially preferably, the composition comprises, consists essentially of, or consists of: 90 wt % of the at least one thermoplastic material comprising thermoplastic polycarbonate/acrylonitrile-butadiene-styrene polymer; 5 wt % of the at least one carbon nanotube; and 5 wt % of the ethylene methyl acrylate.

Method of Preparing Composition

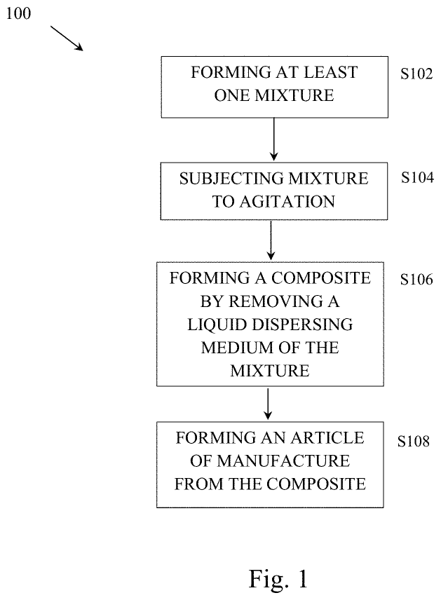

In one embodiment, such as shown in FIG. 1, the thermoplastic polymer composites can be prepared by a method 100 comprising:
(a) combining the particulate thermoplastic material comprising thermoplastic polyurethane, the electrically conductive material comprising carbon nanostructures and the ethylene/alkyl-(meth)acrylate copolymer in a liquid dispersing medium to form at least one mixture S102;
(b) subjecting the mixture to sufficient agitation under high shear to provide a substantially uniform dispersion S104; and
(c) substantially removing the liquid dispersing medium from the dispersion of the subjecting (b) to form the composite, where the particulate thermoplastic material, the carbon nanostructures and the ethylene/alkyl-(meth)acrylate copolymer are distributed substantially uniformly in the composite S106.

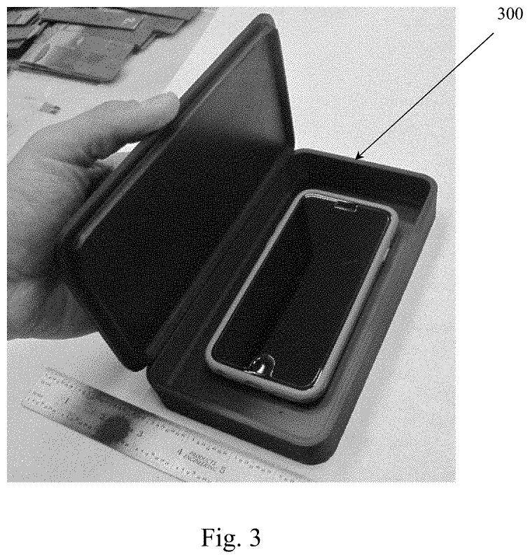

The method 100 may also comprise forming an article of manufacture from the composite S108, such as one of the examples shown in FIGS. 3-6. Of course, in one or more embodiments of the disclosed subject matter methods may comprise providing the composite and forming the article of manufacture from the composite.

The liquid dispersion medium may be solvents, mixtures of solvents, as well as any other substance, composition, compound, etc., which exhibit liquid properties at room or elevated temperatures, etc., and which may also be relatively volatile. Suitable for use as the liquid dispersing medium in one or more methods according to the present disclosure for preparing electrically conductive polymer composites may include one or more of: acetone, ethanol, methanol, chloroform, and dichloromethane.

Optionally, a second mixture may be formed comprising the remaining portion of the plasticizer(s), the nanoscopic particulate filler(s), and the thermal stabilizers dispersed in a second portion of liquid dispersing medium. The liquid dispersing medium used for the first and second mixtures may be the same or different but should be miscible with each other. The combination of the particulate thermoplastic polymers (PC/ABS), the solid functional components (carbon nanostructures), the ethylene/alkyl-(meth)acrylate copolymer, the nanoscopic particulate filler, the plasticizers, and the thermal stabilizers in the liquid dispersing medium (either as one mixture, or as a first mixture and second mixture as described below which is then combined together) may then be agitated sufficiently under high shear to provide a substantially uniform dispersion. After the liquid dispersing medium is substantially removed from the substantially uniform dispersion, what remains is a composite such that the solid components are substantially uniformly distributed in the composite, with the particulate thermoplastic polymers and these solid components within the composite being substantially uniformly coated with the processing additives (e.g., the plasticizers and/or thermal stabilizers). The resulting composite may also be subsequently processed, for example, by extrusion into filaments, such as at a temperature in the range of from about 400° F. to about 550° F., preferably from about 450° F. to about 525° F., particularly preferably from about 445° F. to about 500° F.

A feature of embodiments of the electrically conductive polymer composites can be a conductive network formed by electrically conductive components (e.g., carbon nanotubes) being distributed substantially uniformly in the composite during the process for preparing same, and which is partially or completely preserved during subsequent processing, for example, by extrusion of into filaments. The plasticizers and thermal stabilizers, which function as processing aids, may also aid in adherence of some or all of these electrically conductive components to each other and the particulate thermoplastic polyurethane and/or the nanoscopic particulate fillers.

Embodiments of the disclosed subject matter also relate to preparing thermoplastic polymer composites (including the above-described electrically conductive polymer composites), as well as subsequent processing of these composites to provide, for example, extruded materials, such as filaments. In this method, a mixture may be formed comprising the particulate thermoplastic polymers, all or a portion of the solid functional components (electrically conductive materials), all or a portion of the nanoscopic particulate fillers, and all or a portion of the processing additives (such as the plasticizers, and/or thermal stabilizers) dispersed in one or more liquid dispersing media (which may be comprised of one or more miscible solvents) and in which the processing additives are soluble or otherwise miscible.

Mixing under high shear allows uniform coverage (e.g., deposition) of the processing additives (e.g., the plasticizer and thermal stabilizer) onto the surface of the solids (e.g., the thermoplastic PC/ABS, carbon nanotubes, etc.), as well as allowing for the formation of, for example, three dimensional electrically conductive network, when incorporating electrically conductive materials within the bulk of the composite which is largely preserved after subsequent processing, for example, by extrusion into filaments. By using high shear mixing and evaporation devices in this method enables substantially uniform distribution of the plasticizer and thermal stabilizer, as well as, for example, the solid electrically conductive materials within these composites, thus creating an electrically conductive network throughout the structure of these composites. The composites prepared in this manner may be later deposited/melted/extruded by equipment, such as a screw extruder, to yield electrically conductive articles containing a highly branched framework of conductive pathways (formed by carbon nanostructures) which may allow for higher conductivity of the resulting articles along with a relatively small load of the conductive component(s).

In particular, this process may yield highly electrically conductive polymer composites, as well as articles made from such composites, with a very low volumetric resistivity (e.g., higher conductivity) of about 1 Ohm×cm or below. Alternatively, and by incorporating structural reinforcement materials, relatively non-conductive reinforced thermoplastic polymer composites possessing lower electrical conductivity (higher resistivity) may be obtained, and in some embodiments, electrically conductive materials (e.g., carbon nanostructures) may be added in and amount below percolation threshold, while still providing such non-conductive reinforced thermoplastic polymer nanocomposites.

In another embodiment, the electrically conductive polymer composite may be prepared by a solvent route. In the solvent route, the thermoplastic PC/ABS polymers may be dissolved in the appropriate solvent, such as chloroform or dichloromethane, to form a solution of the thermoplastic PC/ABS polymers. The remaining components of the composite, such as the carbon nanotubes and ethylene/alkyl-(meth)acrylate, may then be added to this solution to form a substantially uniform dispersion of these other components in this solution. The resulting dispersion may then be poured into, for example, a tray, with the solvent being removed, for example, by evaporation of the solvent, or by any other applicable technique for solvent removal. The resulting dry film of electrically conductive polymer composite may then be chopped up or ground, and then used for injection molding and SLS applications, as is or may be dispersed in appropriate media for ink-jet printing applications or may be extruded into a filament, as described above.

Another embodiment involves a method of further improving the mechanical properties (e.g., strength) of these printed conductive architectures by post-processing techniques that enable printed or molded components or parts to be further mechanically altered by drilling, sawing, sanding, or polishing, without significant softening, melting, or disintegrating of the component or part. Upon exiting extruder, the extruded material may be cooled relatively fast before it is collected and spooled. Therefore, the extruded material comprising the thermoplastic PC/ABS polymers (may be amorphous or substantially amorphous, with a relatively low glass transition (Tg) temperature and thus may be lacking any significant mechanical strength. These lower crystallization rates along with lower glass transition (Tg) temperature of the thermoplastic polymers present in these composites may thus limit those applications of these composites where certain mechanical properties may be required. Therefore, increasing the degree of crystallinity of these thermoplastic polymers in these composites may be desirable for improving the mechanical properties of such composites.

Examples of Applications

Examples of uses for these electrically conductive composites (including structurally reinforced electrically conductive polymer composites) according to embodiments of the disclosed subject matter may include, for example: printed electronic circuitry (e.g., circuit boards); conductive traces; flexible circuits; membrane switches; keypads; improved electrodes for rechargeable lithium-ion batteries; thin film batteries; heat sinks for semiconductor laser diodes; roll to roll thick film printing of 3D current conductors; reduction or total replacement of metals in 3D composites such as lightweight, high strength aircraft parts; and catalyst supports.

Examples of commercial applications of these electrically conductive polymer composites (including structurally reinforced electrically conductive polymer composites) may include, for example: solar cell grid collectors, lightning surge, protection, electromagnetic interference shielding (EMI shielding), electromagnetic radiation shields, electrostatic shields, flexible displays, photovoltaic devices, smart labels, myriad electronic devices (music players, games, calculators, cellular phones), decorative and animated posters, active clothing, and RFID tags.

Embodiments these electrically conductive polymer composites may be suitable, for example, for creating “printed conductive circuitry” that may, for example, be deposited, or may be printed using a variety of modern techniques, such as 3D printing, inkjet printing, selective laser sintering (SLS), fused deposition modeling (FDM), injection molding, and other methods. For example, complete conductive circuits, and pathways may be imbedded into an insulating frame or casing and may be printed in one continuous process, easing dramatically the production and assembly of the final component, part or article. These printed conductive pathways may be used to create integrated electrical circuitry (e.g., as printed circuit boards), heat sinks, ion batteries, (super)capacitors, antennae (e.g., RFID tags), electromagnetic interference shielding, electromagnetic radiation shields, solar cell grid collectors, electrostatic shields, or any other application where conductors of electrical current are used. The ability of these electrically conductive polymer composites to be printed together with other components of the final article, component, part, etc., makes their use advantageous compared to other methods (e.g., lithography) due to: higher throughput since all materials may be printed on the same equipment (e.g., printer); better compatibility between components since all materials are polymer based; ability to create complex three-dimensional (3D) structures; ability to seamlessly integrate conductive circuits into the bulk of the final product; simultaneous incorporation of components with single or multiple functionalities; ease of production, since all components may be produced in one process without or minimum post-printing treatment, etc. Alternatively, structurally reinforced non-conductive thermoplastic polymer composites may be formed by such techniques for articles used in, for example, automotive industries, aerospace industries, sports industries.

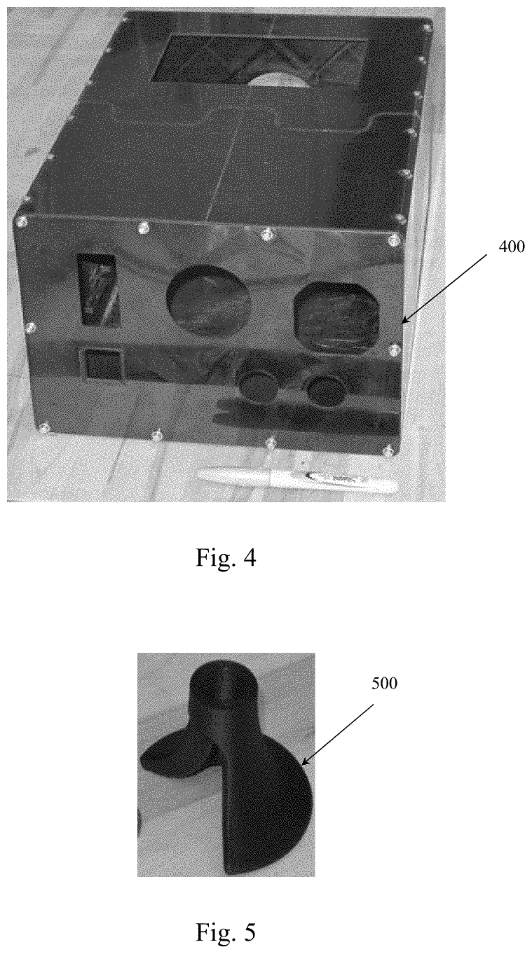

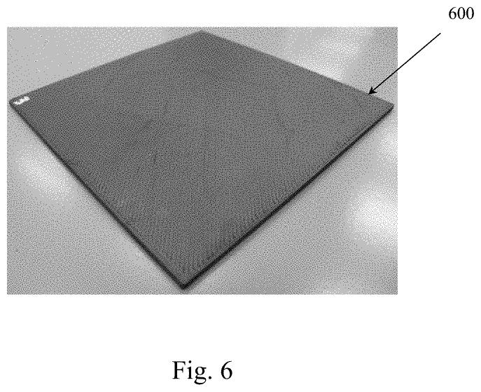

FIGS. 3-6 show examples of articles of manufacture that may be made using compositions according to embodiments of the disclosed subject matter and techniques according to embodiments of the disclosed subject matter. More specifically, FIG. 3 shows an article of manufacture in the form of a mobile device case, FIG. 4 shows an article of manufacture in the form of an EMI shielding enclosure, FIG. 5 shows an article of manufacture in the form of a nozzle, and FIG. 6 shows an article of manufacture in the form of a panel or tile.

As alluded to above, embodiments of the disclosed subject matter can be created using or involve a three-dimensional printing method comprising printing a three-dimensional part comprising a composition according to the disclosed subject matter. Additionally, or alternatively, embodiments of the disclosed subject matter can be created using or involve an injection molding method comprising injecting composition according to the disclosed subject matter into a mold and processing to create an injection molded article of manufacture. In one or more embodiments, the article may be in the form of a plating on a surface of another article, for instance, to create an EMI shield.

Fused Deposition Modeling (FDM) and other Three-Dimensional (3D) Printing

Three-dimensional (3D) additive manufacturing techniques may be used to extrude filaments prepared from these electrically conductive polymer composites through a nozzle and onto a supporting substrate. The precisely controlled (computer controlled) motion of the nozzle in such 3D printing can allow polymer deposition in three dimensions. FDM printing may differ from other 3D printing techniques in using a supportive polymer structure, which may be removed after the model is complete, while other 3D printing techniques may not have to use such supports. These electrically conductive polymer composites may be produced, as described in embodiments of the present disclosure, to be conductive, magnetic, and reinforced, or a combination of such properties, in the form of filaments to fit currently available 3D printers. The compositions of these polymer composites may be altered to enable extrusion of these filaments at conditions used in those printers (e.g., by using plasticizers and other additives). For example, electrically conductive polymer composites may be co-printed together with other non-conductive plastics using multi-nozzle printers, thus building an entire product in one continuous process using a single computer model.

Selective Laser Sintering (SLS)

These electrically conductive polymer composites may also be useful in powdered form (for example by grinding/milling the extruded conductive composite filament) in SLS and similar 3D printing techniques which may enable the production of complex three-dimensional (3D) structures using these polymer composites. These polymer composites may be used in the form of a powdered material which may be heated in the focal point of a laser source, resulting in the local melting and sintering the polymer composite particles together. The movement of the laser focal point in the XY plane, together with the movement of the base containing the polymer precursor in the Z direction, may result in the formation of a 3D object.

Inkjet Printing

These electrically conductive polymer composites may also be useful in inkjet printing, wherein the composite may be deposited through the expulsion of a liquid solution (i.e., composites dissolved, dispersed, etc., in a liquid solvent) thereof from a container under high pressure in the form of small droplets into and onto substrate. Once on the substrate, the solvent may be quickly dried leaving these electrically conductive polymer composites adhered to the surface. Alternatively, the use of solvent may be avoided by using photo-curable materials such as inks, which are liquid in the initial form and which may be printed into or onto the substrate using conventional jet printing methods. Once on the surface, these curable inks may be exposed to light (such as UV light), resulting in the formation of an electrically conductive polymer composite film. These electrically conductive polymer composites may be prepared in the form of an ink suitable for inkjet printing by using, for example, quick drying solvents. For example, the use of ethyl cellulose as a dispersant may enable a very high carbon loading (in the case of these electrically conductive polymer composites) without a significant increase in viscosity, which may be desirable for creating highly conductive and printable inks. These electrically conductive polymer composite dispersions may be also introduced into monomer or oligomer blends containing photoinitiators, electroinitiators, or thermal initiators, thus resulting in a conductive curable ink.

Properties

Tensile Strength

The composition used according to the present disclosure has a tensile strength ranging from 9,000 psi to 10,500 psi, preferably from 9,100 psi to 10,400 psi, particularly preferably from 9,200 to 10,300 psi, especially preferably from 9,300 to 10,250 psi, as measured by ASTM D638.

Tensile Modulus

When injection molded, the composition used according to the present disclosure has a tensile modulus ranging from 550 ksi to 650 ksi, preferably from 575 ksi to 625 ksi, especially preferably from 580 ksi to 600 ksi, as measured by ASTM D638. When 3D printed, the composition used according to the present disclosure has a tensile modulus ranging from 450 ksi to 550 ksi, preferably from 475 ksi to 525 ksi, especially preferably from 490 ksi to 500 ksi, as measured by ASTM D638.

Tensile Elongation

The composition used according to the present disclosure has a tensile elongation ranging from 2.0% to 3.0%, as measured by ASTM D638.

Flexural Strength

When injection molded, the composition used according to the present disclosure has a flexural strength ranging from 16,000 psi to 18,000 psi, preferably from 16,500 psi to 17,750 psi, particularly preferably from 17,000 to 17,500 psi, as measured by ASTM D790. When 3D printed, the composition used according to the present disclosure has a flexural strength ranging from 10,000 psi to 12,000 psi, preferably from 10,500 psi to 11,500 psi, particularly preferably from 10,750 to 11,000 psi, as measured by ASTM D790.

Flexural Modulus

When injection molded, the composition used according to the present disclosure has a flexural modulus ranging from 600 ksi to 800 ksi, preferably from 625 ksi to 750 ksi, particularly preferably from 650 ksi to 700 ksi, as measured by ASTM D790. When 3D printed, the composition used according to the present disclosure has a flexural modulus ranging from 300 ksi to 450 ksi, preferably from 350 ksi to 425 ksi, particularly preferably from 375 ksi to 400 ksi, as measured by ASTM D790.

Un-Notched Impact

When injection molded, the composition used according to the present disclosure has an un-notched impact ranging from 9.00 ft-lb/in. to 9.25 ft-lb/in., preferably from 9.10 to 9.20 ft-lb/in., as measured by ASTM D 4812. When 3D printed, the composition used according to the present disclosure has an un-notched impact ranging from 5.00 ft-lb/in. to 5.50 ft-lb/in., preferably from 5.10 to 5.25 ft-lb/in., as measured by ASTM D 4812.

Notched Impact

The composition used according to the present disclosure has a notched impact ranging from 1.00 ft-lb/in to 1.50 ft-lb/in, preferably from 1.00 ft-lb/in to 1.35 ft-lb/in, as measured by ASTM D256.

Specific Gravity

The composition used according to the present disclosure has a specific gravity ranging from 1.17 to 1.25, preferably from 1.18 to 1.22, especially preferably from 1.19 to 1.20, as measured by ASTM D792.

MAX EMI Shielding

The composition used according to the present disclosure has a MAX EMI SE ranging from 50 dB to 65 dB, as measured by ASTM D4935.

Resistivity

When injection molded, the composition used according to the present disclosure has a resistivity of <1.0 oms-cm, as measured by 4-point Method. Preferably, the resistivity is from 0.200 to 0.500 oms-cm, especially preferably from 0.300 to 0.450 oms-cm, particularly preferably from 0.350 to 0.400 oms-cm. When 3D printed, the composition used according to the present disclosure has a resistivity, as measured by 4-point Method, of from 1.00 to 1.40 oms-cm, especially preferably from 1.10 to 1.30 oms-cm, particularly preferably from 1.20 to 1.25 oms-cm.

Sheet Resistance

When injection molded, the composition used according to the present disclosure has a sheet resistance ranging from <1.0 oms/sq as measured by 4-point Method. Preferably, the sheet resistance is from 0.900 to 0.950 oms/sq, especially preferably from 0.905 to 0.925 oms/sq, particularly preferably from 0.910 to 0.920 oms/sq.

Melt Flow Rate

The composition used according to the present disclosure should have a melt flow rate of greater than 2 grams/10 min at temperatures close to 3D printing, as measured by ASTM D1238. Preferably, the composition has a melt flow rate ranging from 2 to 25 grams/10 min, especially preferably from 5 to 20 grams/10 min, and particularly preferably from 10 to 15 grams/10 min at 3-6 Kg at temperatures close to 3D printing as measured by ASTM D1238.

### EXAMPLES

Inventive Example 1

Preparation of Composition

Multi-walled carbon nanotubes (MWCNT) at 5 wt %, Elvaloy®AC1125 (25% methyl acrylate comonomer content, m.p. 90° C., density 0.944 g/cm³) ethylene/methyl acrylate copolymer at 5 wt.%, and thermoplastic PC/ABS at 90 wt %, was provided and put into a mixer, and then uniformly mixed. The mixture was supplied to the extruder through a hopper. The supplied mixture was melted and kneaded in the extruder and spun through a spinning nozzle. In this case, a screw temperature of the extruder was from 445-500° F. at screw speed range of 165 rpm. The filament was cooled in air at a cooling part, and then the filament was chopped into pellets by a rotating chopper blade.

Injection Molding

The pellets were injection molded, and the shielding effectiveness was tested by ASTM D4935. The tensile strength (psi), tensile modulus (ksi), tensile elongation (%), flexural strength (psi), flexural modulus (ksi), un-notched impact (ft-lb/in), notched impact (ft-lb/in), specific gravity, MAX EMI Shielding up to 1.5 GHz (4 mm THK), resistivity (ohm-cm), and sheet resistance (ohm/sq) are shown in Table 1 below.

3D Printing

The pellets were used to make FDM filament using extrusion process coupled with wire die and were used in a commercially available Desktop 3D printer (LM), and the shielding effectiveness was tested by ASTM D4935. The tensile strength (psi), tensile modulus (ksi), tensile elongation (%), flexural strength (psi), flexural modulus (ksi), un-notched impact (ft-lb/in), notched impact (ft-lb/in), specific gravity, MAX EMI Shielding up to 1.5 GHz (4 mm THK), resistivity (ohm-cm), and sheet resistance (ohm/ sq.) are shown in Table 1 below.

### Comparative Example 1: CY5100 PC/ABS “NEAT”

Preparation of Composition

Sabic TDS CY5100 (PC/ABS) was used as the composition.

The tensile strength (psi), tensile modulus (ksi), tensile elongation (%), flexural strength (psi), flexural modulus (ksi), un-notched impact (ft-lb/in), notched impact (ft-lb/in), specific gravity, MAX EMI Shielding up to 1.5 GHz (4 mm THK), resistivity (ohm-cm), and sheet resistance (ohm/sq) are shown in Table 1 below.

TABLE 1

| | | | 3D Printed (FFF) | |
|---|---|---|---|---|
| | | | | LM Custom |
| | Injection Molded | | | Compound |
| | | LM Custom | | Desktop |
| | | Compound | | Printer |
| | Sabic TDS | PC/ABS | Stratasys TDS | PC/ABS |
| | CY5100 | (CY5100) | Fortus Printer | (CY5100) |
| Typical Material | PC/ABS | x5% CNS | PC/ABS | x5% CNS |
| Properties | “NEAT” | x5% AC1125 | “NEAT” | x5% AC1125* |
| Tensile strength (psi) | 9200 | 10,288 | 5900 | 9240 |
| Tensile Modulus | 400 | 588 | 278 | 500 |
| (ksi) | | | | |
| Tensile Elongation | 4 | 2 | 6 | 2 |
| (%) | | | | |
| Flexural Strength | 13,633 | 17,631 | 9800 | 10,852 |
| (psi) | | | | |
| Flexural Modulus | 354 | 670 | 280 | 408 |
| (ksi) | | | | |
| Un-Notched impact | N/A | 9.12 | 9 | 5.23 |
| (ft-lb/in) | | | | |
| Notched impact | 7.4 | 1.01 | 3.7 | 1.33 |
| (ft-lb/in) | | | | |
| Specific Gravity | 1.1 | 1.198 | 1.1 | 1.173 |
| EMI Shielding @ | None | 50.5 | None | 62.7 |
| 1.5 GHz at 4 mm | | | | |
| THK | | | | |
| Resistivity | 1E+15 | 0.364 | 2E+14 | 1.261 |
| (ohm-cm) | | | | |
| Sheet Resistance | 1E+15 | 0.910 | N/A | 4.205 |
| (ohm/sq.) | | | | |

*X-Y (Flat) Orientation - Max achieved value to date

As demonstrated in Table 1, Example 1 resulted in superior tensile strength, tensile modulus, tensile elongation (%), flexural strength, flexural modulus, un-notched impact, notched impact, specific gravity, conductivity, EMI shielding, resistivity, and sheet resistance properties compared to CY5100 of Comparative Example 1.

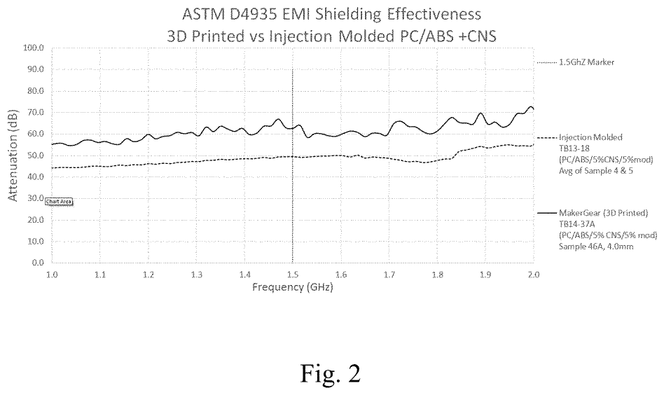

FIG. 2 is a graph showing the EMI shielding effectiveness of Example 1. The x-axis represents frequency (in GHz), and the y-axis represents attenuation (in dB). The top line corresponds to EMI shielding when Example 1 is 3D printed, and the bottom line corresponds to EMI shielding when Example 1 is injection molded. From FIG. 2, it can be seen that the Conductive Plastic compounds of this application are EMI compliant and can be used as a direct replacement of metals or metal coated plastics in specific areas of application.

Compositions according to embodiments of the present disclosure can achieve novel conductive thermoplastics of suitable toughness for injection molding and/or 3D printing articles of manufacture that exhibit desirable electrical performance characteristics (e.g., ESD, EMI, RFI), which may be tailored to a specific application. Furthermore, articles of manufacture made using compositions according to embodiments of the disclosed subject matter can exhibit desirable mechanical properties, such as impact resistance, improved specific strength/modulus, low weight, and improved dimensional stability and service life, for instance, as compared to metal plated thermoplastics. Thus, embodiments of the disclosed subject matter can provide for a low-cost alternative to metal plated thermoplastics.

Definitions

The term “thermoplastic” refers to the conventional meaning of thermoplastic, which is a composition, compound, or material that exhibits the property of a material, such as a high polymer, that softens or melts so as to become pliable or malleable, when exposed to sufficient heat and generally returns to its original condition when cooled to room temperature.

The term “copolymer” refers to polymers containing two or more different monomers. The term “copolymer of various monomers” refers to a copolymer whose units are derived from the various monomers.

The term “(meth)acrylic acid” means methacrylic acid and/or acrylic acid. Likewise, the term “(meth) acrylate” means methacrylate and/or acrylate.

The term “filament” refers to a continuous length of material which has a thread-like structure, having a length which greatly exceeds its diameter, and which may be used with fused filament fabrication (FFF) printer. A filament may be solid or may be fluid, i.e., when liquefied, molten, melted, or softened.

“Electrically conductive” materials may include metals and carbon materials, such as carbon nanofibers, graphene nanoplatelets, as well as combinations thereof.

The term “solid functional components” refers to one or more solid electrically conductive materials or solid structural reinforcement materials.

The term “electrically conductive network” can refers to a conductive network that is formed by the electrically conductive materials present in the composite.

The term “carbon material” refers to materials made of carbon, and which may function as one or more of: electrically conductive materials, structural reinforcement materials, and nanoscopic particulate fillers. Carbon materials may include one or more of: carbon nanofibers (including carbon-based nanotubes); graphite; graphite flakes; carbon black; graphene; and graphene-like materials (e.g., reduced graphene oxide, functionalized graphene, graphene oxide, particularly reduced graphene oxide).

The term “nanoscopic” refers to materials, substances, or structures having a size in at least one dimension (diameter, thickness) of from about 1 to 1000 nanometers, such as from about 1 to about 100 nanometers. Nanoscopic materials, substances, and structures may include, for example, nanoplatelets, nanotubes, Nano whiskers, and flakes.

The term “flakes” refers to particles in which two of the dimensions (i.e., width and length) are significantly greater compared to the third dimension (i.e., thickness).

The term “liquid dispersing medium” refers to a liquid which may dissolve, suspend, etc., another material which may be a solid, gas, or liquid. The liquid dispersion medium may be solvents, mixtures of solvents, as well as any other substance, composition, compound, etc., which exhibits liquid properties at room or elevated temperatures, etc., and which may be also relatively volatile. Suitable for use as the liquid dispersing medium in one or more methods of the present disclosure for preparing electrically conductive polymer composites can include one or more of: acetone, ethanol, methanol, chloroform, and dichloromethane.

The term “plasticizer” refers to the conventional meaning of this term as an additive which, for example, softens, makes more flexible, malleable, pliable, or plastic, a polymer, thus providing flexibility, pliability, and durability, which may also decrease the melting and the glass transition temperature of the polymer, and which may include, for example, one or more of: tributyl citrate; acetyl tributyl citrate; diethyl phthalate; glycerol triacetate; glycerol tripropionate; triethyl citrate, acetyl triethyl citrate; phosphate esters (e.g., triphenyl phosphate, resorcinol bis(diphenyl phosphate), olicomeric phosphate, etc.); long chain fatty acid esters; aromatic sulfonamides; hydrocarbon processing oil; propylene glycol; epoxy-functionalized propylene glycol; polyethylene glycol; polypropylene glycol; partial fatty acid ester (Loxiol GMS 95); glucose monoester (Dehydrat VPA 1726); epoxidized soybean oil; acetylated coconut oil; linseed oil; and epoxidized linseed oil.

The term “melt strength” refers to the resistance of the melted polymer composite to stretching and reflect how strong the polymer composite is when in a molten state. Melt strength of the melted polymer composite is related to the molecular chain entanglements of the polymer in the composite and its resistance to untangling under strain. The polymer properties affecting such resistance to untangling include, for example, molecular weight, molecular-weight distribution (MWD), and molecular branching. As each of these properties increase, melt strength of the polymer may be improved.

The term “extrudable” refers to composition, compound, substance, or material, which is sufficiently malleable, pliable, or thermoplastic, such that it may be forced through an extrusion orifice or die.

The term “fusible” refers to a thermoplastic composition, substance, or material which may be fused, sintered, joined together, or combined by the application of heat.

The term “three-dimensional (3D) printable material” can refer to a thermoplastic composition, substance, or material, which may be formed into a three-dimensional (3D) article (e.g., device, component, object, structure, or part), by a three-dimensional (3D) printing technique. Three-dimensional printing may also be referred to herein as an additive manufacturing technique.

The term “substantially uniform” refers to a composition, dispersion, material, or substance which is substantially uniform in terms of composition, texture, characteristics, and properties.

The term “dispersion” refers to a two (or more)-phase system which may be for, example, in the form of an suspension or a colloid, in which solid materials (e.g., solid particulates, solid particles, solid powders) are dispersed or suspended in the external or continuous (bulk) phase (e.g., the liquid dispersion medium).

The term “room temperature” refers to the commonly accepted meaning of room temperature (an ambient temperature of from about 20° to about 25° C.).

Embodiments of the disclosed subject matter may also be as set forth according to the parentheticals in the following paragraphs.

(1) A composition comprising an electrically conductive polymer composite, the composite comprising: at least one thermoplastic material comprising thermoplastic polycarbonate/acrylonitrile-butadiene-styrene polymer; at least one electrically conductive material comprising carbon nanostructures; and at least one ethylene/alkyl-(meth)acrylate copolymer.

(2) The composition according to (1), wherein the carbon nanostructures are carbon nanotubes.

(3) The composition according to (1) or (2), wherein the at least one ethylene/alkyl-(meth)acrylate copolymer is ethylene methyl acrylate.

(4) The composition according to any one of (1) to (3), wherein the carbon nanostructures are carbon nanotubes, and wherein the at least one ethylene/alkyl-(meth)acrylate copolymer is ethylene methyl acrylate.

(5) The composition according to any one of (1) to (4), comprising, based on the entire composition: 50 to 98 wt % of the at least one thermoplastic material comprising thermoplastic polycarbonate/acrylonitrile-butadiene-styrene polymer; 1 to 20 wt % of the carbon nanotubes; and 1 to 20 wt % of the ethylene methyl acrylate.

(6) The composition according to any one of (1) to (5), comprising, based on the entire composition: 70 to 94 wt % of the at least one thermoplastic material comprising thermoplastic polycarbonate/acrylonitrile-butadiene-styrene polymer; 2 to 15 wt % of the nanotubes; and 2 to 15 wt % of the ethylene methyl acrylate.

(7) The composition according to any one of (1) to (6), consisting of, based the entire composition: 90 wt % of the at least one thermoplastic material comprising thermoplastic polycarbonate/acrylonitrile-butadiene-styrene polymer; 5 wt % of the carbon nanotubes; and 5 wt % of the ethylene methyl acrylate.

(8) A method of preparing a composition comprising an electrically conductive polymer composite, the composition comprising: at least one thermoplastic material comprising thermoplastic polycarbonate/acrylonitrile-butadiene-styrene polymer, at least one electrically conductive material comprising carbon nanostructures, and at least one ethylene/alkyl-(meth)acrylate copolymer, the method comprising: (a) combining particulate thermoplastic material comprising thermoplastic polyurethane, the electrically conductive material comprising carbon nanostructures and the ethylene/alkyl-(meth)acrylate copolymer in a liquid dispersing medium to form at least one mixture; (b) subjecting the mixture to sufficient agitation under high shear to provide a substantially uniform dispersion; and (c) substantially removing the liquid dispersing medium from the dispersion of the subjecting (b) to form the composite, where the particulate thermoplastic material, the carbon nanostructures and the ethylene/alkyl-(meth)acrylate copolymer are distributed substantially uniformly in the composite.

(9) The method according to (8), wherein the carbon nanostructures are carbon nanotubes.

(10) The method according to (8) or (9), wherein the at least one ethylene/alkyl-(meth)acrylate copolymer is ethylene methyl acrylate.

(11) The method according to any one of (8) to (10), wherein the composition comprises: the at least one thermoplastic material comprising thermoplastic polycarbonate/acrylonitrile-butadiene-styrene polymer; at least one carbon nanotube as the carbon nanostructures; and ethylene methyl acrylate as the at least one ethylene/alkyl-(meth)acrylate copolymer.

(12) The method according to any one of (8) to (11), wherein the composition comprises, based on the entire composition: 70 to 94 wt % of the at least one thermoplastic material comprising thermoplastic polycarbonate/acrylonitrile-butadiene-styrene polymer; 2 to 15 wt % of the at least one carbon nanotube; and 2 to 15 wt % of the ethylene methyl acrylate.

(13) The method according to any one of (8) to (12), wherein the composition consists of, based on the entire composition: 90 wt % of the at least one thermoplastic material comprising thermoplastic polycarbonate/acrylonitrile-butadiene-styrene polymer; 5 wt % of the at least one carbon nanotube; and 5 wt % of the ethylene methyl acrylate.

(14) The method according to any one of (8) to (13), further comprising forming an article of manufacture from the composition.

(15) The method according to any one of (8) to (14), wherein the composition has a melt flow rate compatible with fused filament fabrication (FFF).

(16) A method of forming a three-dimensional article of manufacture from an electrically conductive polymer composite, the composite comprising: at least one thermoplastic material comprising thermoplastic polycarbonate/acrylonitrile-butadiene-styrene polymer, at least one electrically conductive material comprising carbon nanostructures, and at least one ethylene/alkyl-(meth)acrylate copolymer, the method comprising: providing the electrically conductive polymer composite; and forming the three-dimensional article of manufacture out of the provided electrically conductive polymer composite.

(17) The method according to (16), wherein said forming the three-dimensional article of manufacture is via fused filament fabrication (FFF) additive manufacturing.

(18) The method according to (16) or (17), wherein said forming the three-dimensional article of manufacture is via injection molding.

(19) The method according to any one of (16) to (18), wherein the article of manufacture is an electromagnetic interference (EMI) enclosure.

Having now described embodiments of the disclosed subject matter, it should be apparent to those skilled in the art that the foregoing is merely illustrative and not limiting, having been presented by way of example only. Thus, although particular configurations have been discussed and illustrated herein, other configurations can be and are also employed. Further, numerous modifications and other embodiments (e.g., combinations, rearrangements, etc.) are enabled by the present disclosure and are contemplated as falling within the scope of the disclosed subject matter and any equivalents thereto. Features of the disclosed embodiments can be combined, rearranged, omitted, etc., within the scope of described subject matter to produce additional embodiments. Furthermore, certain features may sometimes be used to advantage without a corresponding use of other features. Accordingly, Applicant intends to embrace all such alternatives, modifications, equivalents, and variations that are within the spirit and scope of the present disclosure. Further, it is therefore to be understood that within the scope of the appended claims, the disclosure may be practiced otherwise than as specifically described herein.

1: A composition comprising an electrically conductive polymer composite, the composite comprising, based on the entire composition:
50 to 98 wt. % of at least one thermoplastic material comprising thermoplastic polycarbonate/acrylonitrile-butadiene-styrene polymer;
1 to 20 wt. % of at least one electrically conductive material comprising carbon nanostructures; and
1 to 20 wt. % of at least one ethylene/alkyl-(meth)acrylate copolymer.

2: The composition according to claim 1, wherein the carbon nanostructures are carbon nanotubes.

3: The composition according to claim 1, wherein the at least one ethylene/alkyl-(meth)acrylate copolymer is ethylene methyl acrylate.

4: The composition according to claim 1,
wherein the carbon nanostructures are carbon nanotubes, and
wherein the at least one ethylene/alkyl-(meth)acrylate copolymer is ethylene methyl acrylate.

5. (canceled)

6: The composition according to claim 4, comprising, based on the entire composition:
70 to 94 wt. % of the at least one thermoplastic material comprising thermoplastic polycarbonate/acrylonitrile-butadiene-styrene polymer;
2 to 15 wt. % of the carbon nanotubes; and
2 to 15 wt. % of the ethylene methyl acrylate.

7: The composition according to claim 4, consisting of, based the entire composition:
90 wt. % of the at least one thermoplastic material comprising thermoplastic polycarbonate/acrylonitrile-butadiene-styrene polymer;
5 wt. % of the carbon nanotubes; and
5 wt. % of the ethylene methyl acrylate.

8: A method of preparing a composition according to claim 1, the method comprising:
(a) combining the at least one thermoplastic material comprising thermoplastic polyurethane, the at least one electrically conductive material comprising carbon nanostructures, and the at least one ethylene/alkyl-(meth)acrylate copolymer in a liquid dispersing medium to form at least one mixture;
(b) subjecting the mixture to sufficient agitation to provide a substantially uniform dispersion; and
(c) substantially removing the liquid dispersing medium from the dispersion of the subjecting (b) to form the electrically conductive polymer composite, where the at least one thermoplastic material, the at least one electrically conductive material comprising carbon nanostructures, and the at least one ethylene/alkyl-(meth)acrylate copolymer are distributed substantially uniformly in the electrically conductive polymer composite.

9: The method according to claim 8, wherein the carbon nanostructures are carbon nanotubes.

10: The method according to claim 8, wherein the at least one ethylene/alkyl-(meth)acrylate copolymer is ethylene methyl acrylate.

11: The method according to claim 8, wherein the composition comprises:
the at least one thermoplastic material comprising thermoplastic polycarbonate/acrylonitrile-butadiene-styrene polymer;
at least one carbon nanotube as the carbon nanostructures; and
ethylene methyl acrylate as the at least one ethylene/alkyl-(meth)acrylate copolymer.

12: The method according to claim 11, wherein the composition comprises, based on the entire composition:
70 to 94 wt. % of the at least one thermoplastic material comprising thermoplastic polycarbonate/acrylonitrile-butadiene-styrene polymer;
2 to 15 wt. % of the at least one carbon nanotube; and
2 to 15 wt. % of the ethylene methyl acrylate.

13: The method according to claim 11, wherein the composition consists of, based on the entire composition:
90 wt. % of the at least one thermoplastic material comprising thermoplastic polycarbonate/acrylonitrile-butadiene-styrene polymer;
5 wt. % of the at least one carbon nanotube; and
5 wt. % of the ethylene methyl acrylate.

14: The method according to claim 8, further comprising forming an article of manufacture from the composition.

15: The method according to claim 8, wherein the composition has a melt flow rate compatible with fused filament fabrication (FFF).

16: A method of forming a three-dimensional article of manufacture from a composition according to claim 1, the method comprising:
providing the electrically conductive polymer composite; and
forming the three-dimensional article of manufacture out of the provided electrically conductive polymer composite.

17: The method according to claim 16, wherein said forming the three-dimensional article of manufacture is via fused filament fabrication (FFF) additive manufacturing.

18: The method according to claim 16, wherein said forming the three-dimensional article of manufacture is via injection molding.

19: The method according to claim 16, wherein the article of manufacture is an electromagnetic interference (EMI) enclosure.
